(19) United States
(12) Patent Application Publication
(10) Pub. No.: US 2013/0161249 A1
(43) Pub. Date: Jun. 27, 2013

(54) IN-TANK FILTER FOR FUEL PUMP MODULE

(71) Applicant: COAVIS, Yeongi-gun (KR)

(72) Inventor: Ku Sung KWON, Daejeon (KR)

(73) Assignee: COAVIS, Yeongi-gun (KR)

(21) Appl. No.: 13/671,650

(22) Filed: Nov. 8, 2012

(30) Foreign Application Priority Data
Dec. 26, 2011 (KR) 10-2011-0142155

(51) Int. Cl. B01D 35/30

(52) U.S. Cl. CPC B01D 35/30
USPC 210/232

(57) ABSTRACT

Provided is an in-tank filter for a fuel pump module. The in-tank filter for a fuel pump module includes: a filter media filtering foreign materials; a container having the filter media received therein and having a hose connector to which a hose for supplying fuel passing through the filter media is connected; and a retainer having the container rotatably coupled thereto to allow a direction toward which the hose connector is directed or a position of the hose connector to be adjustable and allowing the container to be installed in a reservoir body assembly. With the in-tank filter for a fuel pump module, a routing operation of connecting the hose for supplying fuel to the hose connector may be easily and rapidly performed. In addition, since each of the molds meeting a specification of the fuel pump module needs not to be provided, economical efficiency is excellent.

### CROSS-REFERENCE TO RELATED APPLICATIONS

This application claims priority under 35 U.S.C. §119 to Korean Patent Application No. 10-2011-0142155, filed on Dec. 26, 2011, in the Korean Intellectual Property Office, the disclosure of which is incorporated herein by reference in its entirety.

### TECHNICAL FIELD

The following disclosure relates to an in-tank filter, which is a component of a fuel pump module positioned in a fuel tank of a vehicle, or the like, to supply fuel to an engine.

### BACKGROUND

A vehicle, or the like, driven by receiving liquid fuel, such as a gasoline engine or a diesel engine, is provided with a fuel tank in which fuel is stored.

In addition, the vehicle is provided with a fuel pump module for forcibly supplying the fuel filled in the fuel tank to the engine.

The fuel pump module is generally configured to include a flange assembly 1, a reservoir body assembly 2, a guide rod 3 connecting the flange assembly 1 and the reservoir body assembly 2 to each other, a spring 4 positioned at an outer side of the guide rod 3, and an in-tank filter 5 removing foreign materials included in fuel, as shown in FIGS. 1 and 2.

In most cases, the flange assembly is fixed to an inlet portion of a fuel tank, and the reservoir body assembly is positioned on the bottom of the fuel tank.

In addition, the guide rod, which connects the flange assembly and the reservoir body assembly to each other while guiding movement of the spring, is configured to slidably move to an inner side of the reservoir body assembly.

Further, the spring is positioned at the outer side of the guide rod, and is positioned between the flange assembly and the reservoir body assembly to allow the reservoir body assembly to be always positioned on the bottom of the fuel tank.

The in-tank filter has been generally configured to include upper and lower containers 5a and 5b coupled to each other, a filter media 5c positioned at an inner side of the upper and lower containers 5a and 5b coupled to each other, a hose connector 5e coupled to an upper portion of the upper container 5a and connected (generally referred to as ‘routed’) to a hose 6 moving fuel to the outside of the in-tank filter, and a retainer 5d fixing the in-tank filter to the reservoir body assembly.

Korean Patent Application No. 10-2010-0026233, and the like, has suggested a structure of an in-tank filter for a fuel pump module.

The in-tank filter shown in FIG. 1 and an in-tank filter shown in FIGS. 3 and 4 are different in a shape from each other, but are the same in action as each other.

FIGS. 3 and 4 are perspective views for describing a general in-tank filter.

However, since a hose connector formed at the in-tank filter according to the related art has a form in which it is fixed toward only one direction, it is difficult to perform an operation of setting a bent angle of a hose for supplying fuel, such that it is inconvenient to perform an operation of connecting the hose for supplying fuel to the hose connector of the in-tank filter and an operation time increases, thereby reducing productivity.

In order to solve these problems, each of the molds for manufacturing retainers meeting each condition so that a routing operation is easy may be provided. However, in this case, since a large number of molds should be secured, an increase in a manufacturing cost may be caused.

### RELATED ART DOCUMENT

### Patent Document

Korean Patent Application No. 10-2010-0026233

### SUMMARY

An embodiment of the present invention is directed to providing an in-tank filter for a fuel pump module capable of improving productivity and reducing economic loss that has been generated due to necessity for securing various forms of molds, by allowing a direction toward which a hose connector of the in-tank filter is directed to be adjusted to allow a routing operation of connecting a hose for supplying fuel to the hose connector to be easily and rapidly performed.

In one general aspect, there is provided an in-tank filter for a fuel pump module in which a hose connector to which a hose for supplying fuel is connected is formed at a container receiving a filter media therein and the container receiving the filter media therein is rotatably coupled to a retainer to allow a direction toward which the hose connector is directed to be adjustable according to a specification of a fuel pump module, thereby making it possible to allow a routing operation of connecting the hose for supplying fuel to the hose connector to be easily and rapidly performed.

The in-tank filter for a fuel pump module includes a filter media filtering foreign materials.

In addition, the in-tank filter for a fuel pump module includes a container having the filter media received therein and having a hose connector to which a hose for supplying fuel passing through the filter media is connected.

Further, the in-tank filter for a fuel pump module includes a retainer having the container rotatably coupled thereto to allow a direction toward which the hose connector is directed or a position of the hose connector to be adjustable and allowing the container to be installed in a reservoir body assembly.

### BRIEF DESCRIPTION OF THE DRAWINGS

FIG. 1 is an exploded perspective view of a fuel pump module according to the related art.

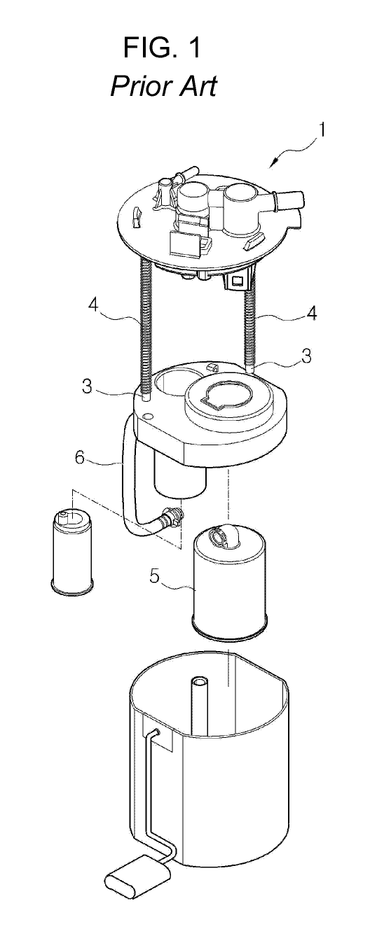

FIG. 2 is a perspective view of the fuel pump module according to the related art.

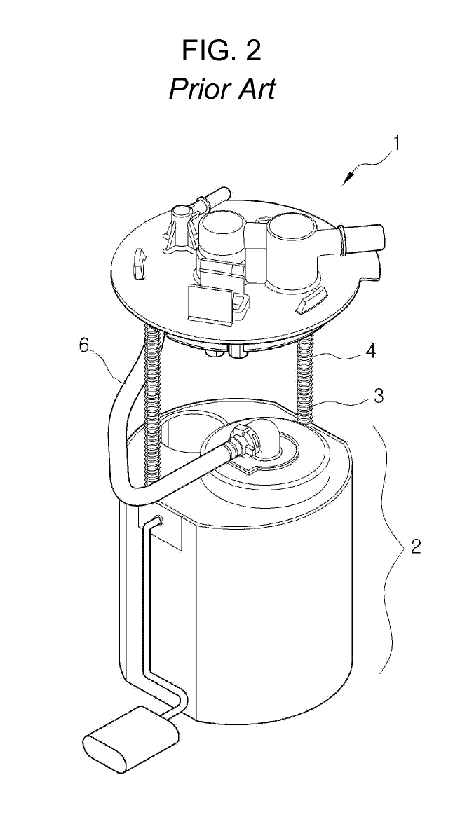

FIG. 3 is an exploded perspective view for describing an in-tank filter according to the related art.

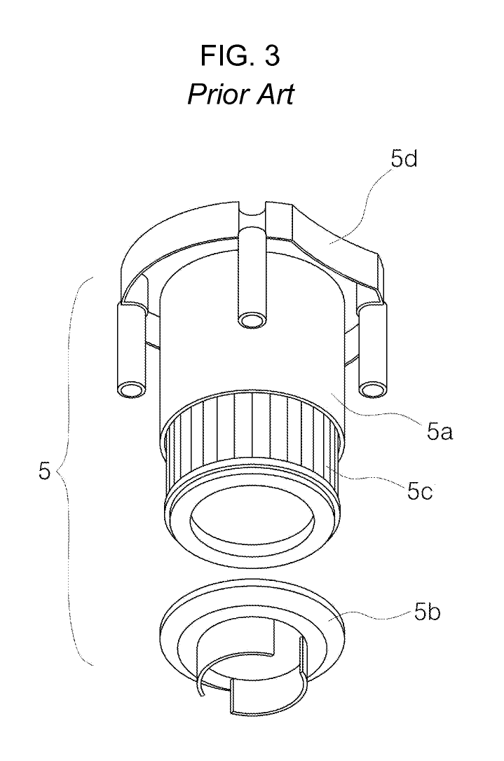

FIG. 4 is a perspective view of the in-tank filter for describing a hose connector formed at the fuel pump module according to the related art.

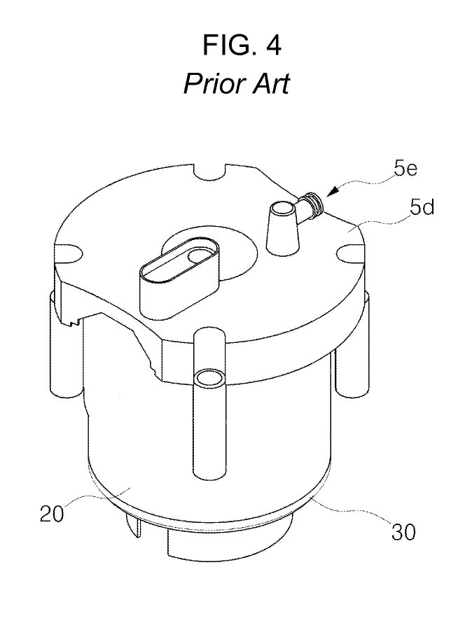

FIG. 5 is an exploded perspective view of an in-tank filter for a fuel pump module according to an exemplary embodiment of the present invention.

FIG. 6 is a perspective view showing an assembled state of a container and a filter, which are components of the in-tank filter for a fuel pump module according to the exemplary embodiment of the present invention.

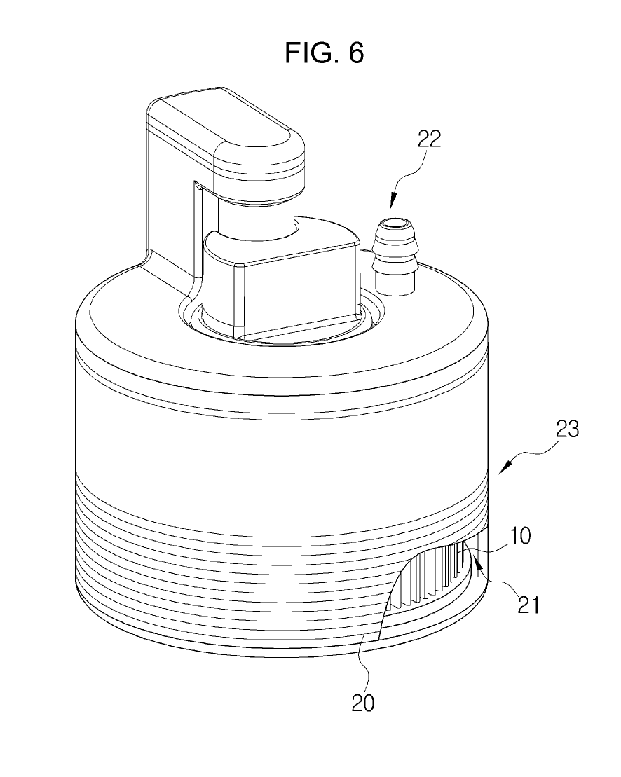

FIG. 7 is a perspective view of an assembled state of the in-tank filter for a fuel pump module shown in FIG. 5 and a perspective view of a reservoir body assembly case.

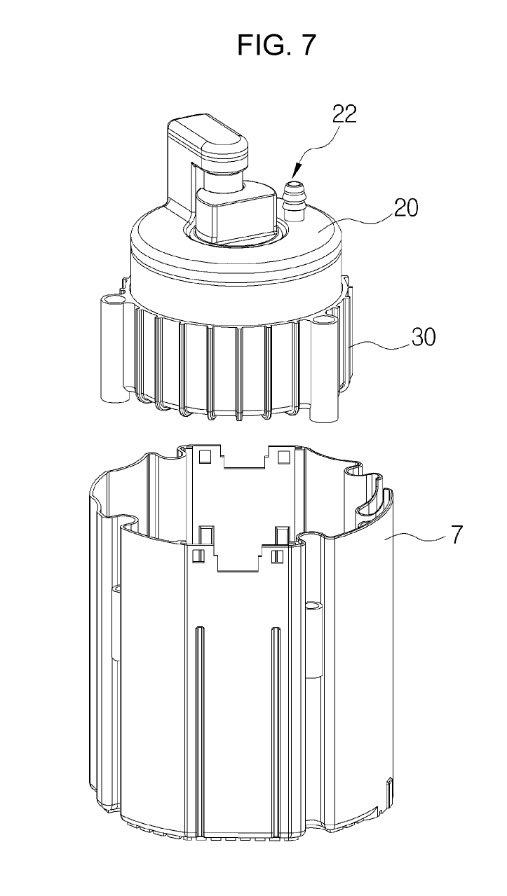

### DETAILED DESCRIPTION OF MAIN ELEMENTS

1: Flange assembly

2: Reservoir body assembly

3: Guide rod

4: Spring

5: In-tank filter

5a: Upper container

5b: Lower container

5c: Filter media

5d: Retainer

5e: Hose connector

6: Hose

7: Reservoir body assembly case

10: Filter media

20: Container

21: Filter media insertion space

22: Hose connector

23: Spiral

30: Retainer

31: Container insertion hole

31a: Spiral

### DETAILED DESCRIPTION OF EMBODIMENTS

Hereinafter, a technical spirit of the present invention will be described in more detail with reference to the accompanying drawings.

However, the accompanying drawings are only examples shown in order to describe the technical idea of the present invention in more detail. Therefore, the technical idea of the present invention is not limited to shapes of the accompanying drawings.

The present invention relates to an in-tank filter for a fuel pump module.

Therefore, the in-tank filter 100 for a fuel pump module according to the exemplary embodiment of the present invention includes a filter media 10 filtering foreign materials as in the case according to the related art.

In addition, the in-tank filter 100 for a fuel pump module according to the exemplary embodiment of the present invention includes a container 20 having a filter media insertion space 21 in which the filter media 10 is insertedly received.

Further, the in-tank filter 100 for a fuel pump module according to the exemplary embodiment of the present invention includes a retainer 30 allowing the container 20 receiving the filter media 10 therein to be installed in a reservoir body assembly.

The container receiving the filter media 10 therein may have a form in which upper and lower containers are coupled to each other and the lower container blocks a lower portion of the upper container.

An object of the present invention is to provide an in-tank filter for a fuel pump module capable of improving productivity and reducing economic loss that has been generated due to necessity for securing various forms of molds, by allowing a direction toward which a hose connector of the in-tank filter is directed to be adjusted to allow a routing operation of connecting a hose for supplying fuel to the hose connector to be easily and rapidly performed.

To this end, a hose connector 22 is formed at a container 20.

That is, the hose connector to which a hose 6 for supplying fuel (that is, a hose for supplying fuel passing through the filter media 10) is connected is formed at the container.

Further, the retainer 30 is configured so that it has the container 20 rotatably coupled thereto to allow a direction toward which the hose connector 22 is directed or a position of the hose connector 22 to be adjustable.

According to the above-mentioned configuration, since the direction toward which the hose connector 22 is directed or the position of the hose connector 22 may be adjusted by rotating the container 20 based on a fixed retainer 30, a routing operation of connecting the hose 6 for supplying fuel to the hose connector 22 is easy.

After the hose routing operation ends, the container 20 and the retainer 30, which are components of the in-tank filter 100 for a fuel pump module according to the exemplary embodiment of the present invention, may be welded or adhered to each other to allow an installation state not to be changed.

In order to allow the hose routing operation to be easily performed according to a specification of the fuel pump module, it is also possible to install the in-tank filter in the reservoir body assembly in the state in which the retainer 30 and the container 20 are coupled to each other and then welded or adhered to each other so that a coupled state therebetween is not changed and then performing the routing operation.

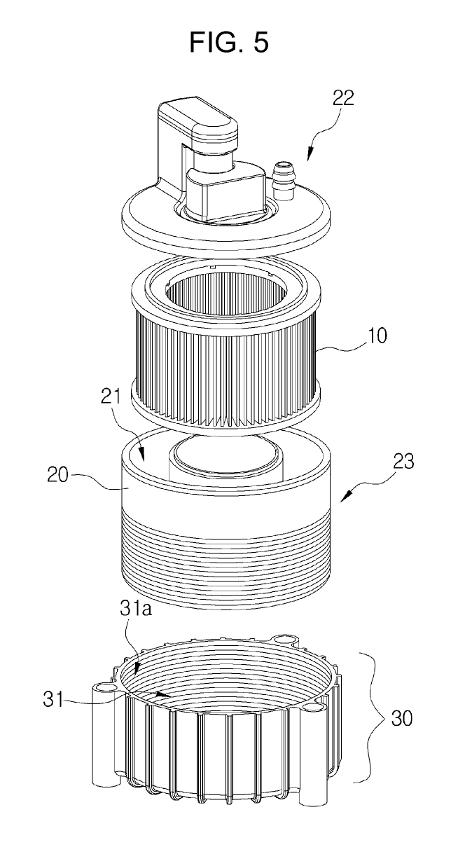

In FIG. 5, the retainer 30 has a container insertion hole 31 into which the container 20 is inserted and at which a spiral 31a is formed.

In addition, the container 20 has a spiral 23 coupled to the spiral 31a formed at the container insertion hole 31 of the retainer 30.

In this configuration, the container 20 may be spiral-coupled to the container insertion hole 31 of the retainer 30 (in a scheme of fastening a bolt) to couple the container 20 and the retainer 30 to each other, a rotation degree of the container 20 may be adjusted to allow the hose connector 22 formed at the container 20 to be directed toward a specific direction or to be positioned at a specific position, and the container 20 and the retainer 30 may be then welded or adhered to each other by an adhesive, or the like, so that a coupled state therebetween is not changed.

In the case in which the welding is performed, it is sufficient only to perform spot welding and it is preferable to perform welding in a heat fusing scheme or a laser fusing scheme.

Although a structure in which the spiral 31a is formed at container insertion hole 31 is shown in FIG. 5, the structure of FIG. 5 may also be implemented in a form in which the spiral 31a or 23 is omitted.

In this case, when the container 20 is inserted in the container insertion hole 31 of the retainer 30, the container insertion hole 31 may have a diameter larger than an outer diameter of the container 20 by about 0.05 to 0.5 mm.

The structure in which the container 20 and the retainer 30 are spiral-coupled to each other as shown in FIG. 5 is more preferable than other structures.

According to the exemplary embodiment of the present invention, it is preferable to implement the container 20 so as to rotate by 360 degrees based on the retainer 30.

Reference numeral 7 that is not described indicates a reservoir body assembly case.

In the in-tank filter for a fuel pump module according to the exemplary embodiment of the present invention, the hose connector is formed at the container receiving the filter media therein and the container receiving the filter media therein is rotatably coupled to a retainer to allow the direction toward which the hose connector is directed to be adjustable according to the specification of the fuel pump module, thereby making it possible to allow the routing operation of connecting the hose for supplying fuel to the hose connector to be easily and rapidly performed. In addition, since each of the molds meeting the specification of the fuel pump module needs not to be provided, economical efficiency is excellent.

The container is inserted in the retainer, which is the component of the in-tank filter for a fuel pump module according to the exemplary embodiment of the present invention, the container insertion hole at which the spiral is formed is formed in the retainer, and the container has the spiral coupled to the spiral formed at the container insertion hole of the retainer, such that when the container is coupled to the retainer, the container may be fixed without shaking.

In addition, the container and the retainer are welded or adhered to each other so that a coupled state therebetween is not changed in the state in which the container is inserted into the container insertion hole, thereby making it possible to make the coupled state between the retainer and the container firm.

What is claimed is:

1. An in-tank filter for a fuel pump module, comprising:
a filter media filtering foreign materials;
a container having the filter media received therein and having a hose connector to which a hose for supplying fuel passing through the filter media is connected; and
a retainer having the container rotatably coupled thereto to allow a direction toward which the hose connector is directed or a position of the hose connector to be adjustable and allowing the container to be installed in a reservoir body assembly.

2. The in-tank filter for a fuel pump module of claim 1, wherein the retainer has a container insertion hole into which the container is inserted.

3. The in-tank filter for a fuel pump module of claim 1, wherein the retainer has a container insertion hole into which the container is inserted and at which a spiral is formed, and
the container has a spiral coupled to the spiral formed at the container insertion hole of the retainer.

4. The in-tank filter for a fuel pump module of claim 1, wherein the container and the retainer are welded or adhered to each other so that a coupled state there between is not changed in the state in which the container is inserted into the container insertion hole.

5. The in-tank filter for a fuel pump module of claim 1, wherein the container and the retainer are welded to each other in a heat fusing scheme or a laser fusing scheme so that a coupled state there between is not changed in the state in which the container is inserted into the container insertion hole.
